(19) United States
(12) Patent Application Publication
(10) Pub. No.: US 2013/0124706 A1
(43) Pub. Date: May 16, 2013

(54) SCALABLE NETWORKED DEVICE DYNAMIC MAPPING

(71) Applicants: Mordehai Margalit, Zichron Yaaqov (IL); Benjamin Maytal, Mevassret-Zion (IL)

(72) Inventors: Mordehai Margalit, Zichron Yaaqov (IL); Benjamin Maytal, Mevassret-Zion (IL)

(73) Assignee: Empire Technology Development, LLC, Wilmington, DE (US)

(21) Appl. No.: 13/511,651

(22) PCT Filed: Nov. 14, 2011
(86) PCT No.: PCT/US11/60580

§ 371 Date: May 23, 2012

(51) Int. Cl. G06F 15/173

(52) U.S. Cl. 709/223

(57) ABSTRACT

Technologies are generally described for providing a system of scalable networked devices that may be mapped employing a naming convention that enables an optimized route to the devices through device search algorithms for network-connected and non-network connected devices. The naming convention and corresponding algorithms may enable users to search for a desired functionality, access suitable scalable networked device(s), and utilize the desired functionality. Furthermore, a spider algorithm may be employed to continuously map and update a mesh of scalable networked devices.

### BACKGROUND

Unless otherwise indicated herein, the materials described in this section are not prior art to the claims in this application and are not admitted to be prior art by inclusion in this section.

Ubiquitous computing (ubicomp) is a post-desktop model of human-computer interaction in which information processing is integrated into everyday objects and activities. According to this computing model, people using ubiquitous computing may engage a number of computational devices and systems simultaneously, and may not necessarily be aware that they are doing so. Various models of ubiquitous computing share common attributes directed to small, inexpensive, robust, networked input and processing devices, distributed at various scales throughout everyday life and generally turned to distinctly common-place ends. For example, a home ubiquitous computing environment may interconnect lighting and environmental controls with personal biometric monitors woven into clothing so that illumination and heating conditions in a room may be modulated, continuously and imperceptibly. Another example may include performing an Internet search for temperature or similar environmental parameters at a remote location, and the search retrieving results from a number of sensors through a scalable networked device system.

Ubiquitous computing presents challenges in systems design and engineering, in systems modeling, and in user interface design. Contemporary human-computer interaction models, whether command-line, menu-driven, or graphical user interface based, may be inadequate or not suitable to the ubiquitous model. A ubiquitous computing network may include very large numbers of devices. Location, functionality, network connection, and status of such devices may be highly variable. Thus, it is a challenging task to continuously map these devices so that users can access the devices remotely and utilize their functionality.

### SUMMARY

The present disclosure generally describes techniques for a scalable networked device to join a network. According to some embodiments, a method may include attempting to obtain a network identifier at a first scalable networked device and providing first scalable networked device information to a network management server such that the first scalable networked device becomes discoverable within the network based on at least one of a name, a functionality, and/or a status of the first scalable networked device if the network identifier is obtained. The method may also include performing a search at the first scalable networked device for at least a second scalable networked device that is communicatively coupled to the first scalable networked device upon acknowledgment by the network management server.

The present disclosure also describes a scalable networked device that includes a memory configured to store instructions, a wireless communication module, and a processing unit configured to communicate with a network in conjunction with the stored instructions. The processor may attempt to obtain a network identifier, provide information to a network management server such that the scalable networked device becomes discoverable within the network based on at least one of a name, a functionality, and/or a status of the scalable networked device if the network identifier is obtained, and perform a search for at least one other scalable networked device that is communicatively coupled to the scalable networked device upon acknowledgment by the network management server.

The present disclosure further describes a system of discoverable scalable networked devices that includes a first server, a second server, and a plurality of scalable networked devices. The first server may provide a network identifier to each scalable networked device directly coupled to a network. The second server may receive device information tables from each scalable networked device directly coupled to the network and render the scalable networked devices discoverable by publishing the device information tables, where the device information tables include a name, a functionality, a location, and/or a status of each scalable networked device directly or indirectly coupled to the network. A name of each scalable networked device may identify a route of the device.

The present disclosure also describes a method for updating a scalable networked device network status. The method may include broadcasting an initial signal to the scalable networked devices that include a network identifier of a first scalable networked device in their routes, upon receiving an acknowledgment, requesting device information from responding scalable networked devices, and for each responding scalable networked device, recursively requesting device information from other scalable networked devices coupled to the responding devices until layers of scalable networked devices associated with the first scalable networked device are exhausted. The method may also include associating the scalable networked device with the network identifier of the first scalable networked device if a scalable networked device without a network identifier in its name is discovered.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 illustrates an example networked system of discoverable scalable networked devices;

FIG. 2 illustrates another example configuration of the system of FIG. 1, where some scalable networked devices may be defined by more than one route/name;

FIG. 3 illustrates example functional modules of a scalable networked device;

FIG. 4 illustrates a special purpose processor that may be employed in a scalable networked device;

FIG. 5 illustrates a general purpose computing device, which may be used to implement scalable networked device dynamic mapping;

FIG. 6 is a flow diagram illustrating an example method for starting up a scalable networked device such as one of the devices in FIG. 1 or FIG. 2;

FIG. 7 is a flow diagram illustrating an example method for searching for other devices by a network-connected scalable networked device such as device 110 in FIG. 1;

FIG. 8 is a flow diagram illustrating an example method for searching for other devices by a non-network-connected scalable networked device such as device 115 in FIG. 1; and

FIG. 9 illustrates a block diagram of an example computer program product, all arranged in accordance with at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

This disclosure is generally drawn, inter alia, to methods, apparatus, systems, devices, and/or computer program products related to mapping to and managing scalable networked devices such that users are enabled to search for functionality, access one or more devices based on search results, and utilizing the sought functionality provided by the one or more devices.

Briefly stated, a system of scalable networked devices may be mapped by employing a naming convention that enables an optimized route to the devices through device search algorithms for network-connected and non-network connected devices. The naming convention and corresponding algorithms may enable users to search for a desired functionality, access suitable scalable networked device(s), and utilize the desired functionality. Furthermore, a spider algorithm may be employed to continuously map and update a mesh of scalable networked devices.

As used herein, the term “scalable networked device” refers to any device capable of detecting/receiving/processing information and providing data to other computing devices over one or more networks. Such devices may have a variable range of capabilities and sizes. A limited set of illustrative examples for such devices may include sensors, radio frequency identification (RFID) tags, location determination devices, interactive whiteboards, monitoring devices, and/or alarm devices. These devices may also be referred to as ubiquitous computing devices. A Network Center Server (NCS) may be a network device, connectable over the Internet or similar networks through a network address and may be used for storage and indexing of scalable networked device information. A Network Connected Device (NCD) may be a ubiquitous computing device directly connected to the network(s) (e.g., the Internet) and having an assigned network identifier (e.g., an IP address). A Standalone Device (SAD) may be a ubiquitous computing device without a network identifier (e.g., an IP address) and no direct connection to the network(s) (e.g., the Internet). Thus, all connections to SADs in a system according to embodiments are through a direct or indirect route to one or more NCDs.

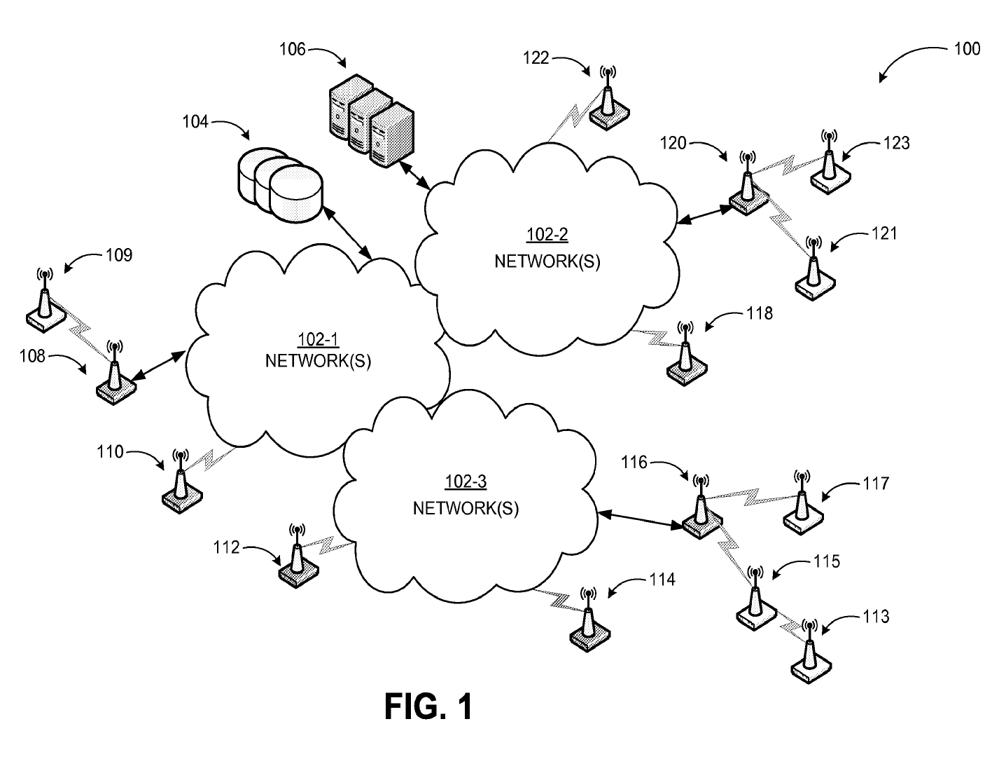

FIG. 1 illustrates an example networked system of discoverable scalable networked devices, arranged in accordance with at least some embodiments described herein.

As mentioned previously, scalable networked devices or ubiquitous computing devices include a wide range of devices such as mobile phones, digital audio players, sensors, radio-frequency identification tags, location determination devices, cameras, interactive whiteboards, and similar devices. In an increasingly interconnected world, the scalable networked devices can perform a wide range of functionality without a large overhead that is typically associated with complicated multi-component systems. For example, relatively simple and cost-effective weather sensors may be placed in a large number of locations and accessed on-demand instead of computers with sensors attached and wired or wireless connections complete with the needed networking infrastructure.

The simplicity of the scalable networked devices is not limited to their construction, but also to their use and the architecture of the networked system utilizing such devices. For example, standard network topologies may demand that every computing device interacting with a network be assigned a network identifier such as an IP address. The scalable networked devices in a system according to embodiments do not need to have assigned network identifiers or be connected to a network directly, however, thus relieving the network from the overhead of a large number of devices having to be maintained architecturally. A system of scalable networked devices according to embodiments may be mapped employing a naming convention that enables an optimized route to the devices through device search algorithms for network-connected and non-network connected devices.

Referring to a diagram 100 in FIG. 1, an example system may include multiple networks 102-1 through 102-3, and multiple administration servers 106 (and/or specialized devices such as routers, firewalls, etc.). Scalable networked devices may be connected directly to one of the networks 102-1 through 102-3 (referred to as NCD) or connected to one of the networks through one or more other scalable networked devices (referred to as SAD). Thus, an NCD is directly connected to a network and has a network identifier, and an SAD is connected to a network through at least an NCD and zero or more SADs and does not have a network identifier.

In the example scenario depicted by the diagram 100, an NCD 108 is connected to the network 102-1 through a wired connection, while an NCD 110 is connected to the network 102-1 through wireless means. An SAD 109 is connected to the network 102-1 through the NCD 108. NCDs 112, 114, and 116 are connected to the network 102-3 directly. SADs 115 and 117 are connected to the network 102-3 through the NCD 116 illustrating that multiple SADs can be coupled to a network through a single NCD. An SAD 113 is connected to the network 102-3 through the SAD 115 and the NCD 116 illustrating a serial connection. NCDs 118, 120, and 122 are connected to the network 102-2 directly, while SADs 121 and 123 are connected to the network 102-2 through the NCD 120. Network operation and other data may be stored in one or more centralized or distributed data stores 104, which may be connected to various networks or to one of the networks (e.g., the network 102-1 in the diagram 100).

To enable efficient mapping of SADs and NCDs, a device naming nomenclature may be adopted. According to the naming convention, a device name may be composed of two parts: a network identifier of an NCD and a route through SADs to specific device termed, for example, SAD0. Thus, [device name of SAD0]=[network identifier of NCD] [SADN] [SADN−1] . . . [SAD2] [SAD1], where N is the number of devices between SAD0 and the NCD through which SAD0 accesses the network(s). The device name defines the route to the device and can be used to transmit or receive information from the device. The device name is bound to be unique to the particular device, though a device can have more than one name (routes).

A start-up procedure for a new scalable networked device may begin with testing network connectivity by attempting to get a network identifier from a server (e.g., an IP address from a DHCP server). If a new scalable networked device can obtain the network identifier, the device is an NCD and the network identifier may be provided as the name for the new device to an NCS along with a functionality, location, status, and similar information about the device. The NCS may store this information and mirror to designated search locations in the network, similar to a Domain Name Server functionality. The location of the NCD may not always be known. In this case, the location may be determined by a nearest SAD or NCD, which has location information and is adjacent in the network connection to the device. Once NCD is connected to an NCS, a device search algorithm may be initiated for another network connected device. If the new device cannot get a network identifier, on the other hand, a device search algorithm for a non-network connected device may be initiated.

The search for other network connected devices may include searching available communication channels for other scalable networked devices that may be by default in listening mode. The search may begin with an initial signal (e.g., a “hello” signal). Devices hearing the hello signal may send a response using a collision detection algorithm, for example. Once a device is acknowledged, it may transfer its name to the searching NCD if the device already has a name (route). The NCD may decide if the new route is better than an existing route, and add the new device name or change depending on which route is more efficient. If a responding device has no name, the (discovered) device is not yet connected to network via the searching NCD. The device name may be set to the NCD's network identifier and a location in device location table of the NCD sending the hello signal. The discovered device is now connected to network. The network may be updated on a functionality and status of the discovered device.

The device search for non-network connected devices (i.e., no network identifier in name) may also begin with a transmission of a “hello” signal to listening devices. If a responding scalable networked device has a network identifier in its name, the searching device (SAD) may add itself to the route by selecting the name and sending functionality and status information via the route of SADs defined in name to the NCD. The recursive search may continue up to a predefined number of network connected devices if desired. If a responding scalable networked device has no network identifier in its name, on the other hand, the search may ignore that device continue to next device. Once the searching device is named with a path to network, the search algorithm for network connected device may be initiated recursively.

In some embodiments, a spider action search may be initiated at an NCD by transmitting a “hello” signal to devices that include the NCD's network identifier in their names. The status of each device may be queried. If a device is discovered without the network identifier in its name, that device may be added to the network and the search algorithm for network connected device initiated recursively. If a device with a different network identifier is discovered, the searching device (NCD) may determine whether to keep the discovered device's existing name, change the name, or add a new name with the NCD's network identifier.

If a user wishes to perform a function with a scalable networked device, the user may send a query via one or more networks (e.g., the Internet) using a search engine, for example. The search may define the functionality and location of the desired scalable networked device. The search may be conducted on the device information tables found on the NCS mirrors, and return the name of the scalable networked device. The name is the route to the scalable networked device. Using the network identifier of the NCD, the user can then send a query to the NCD, which forwards the query through the SAD route to the SAD, which has been identified by the search. The scalable networked device may return the answer to the query through the SAD route back to the NCD. The NCD may forward the answer to the query back to the user through the network(s).

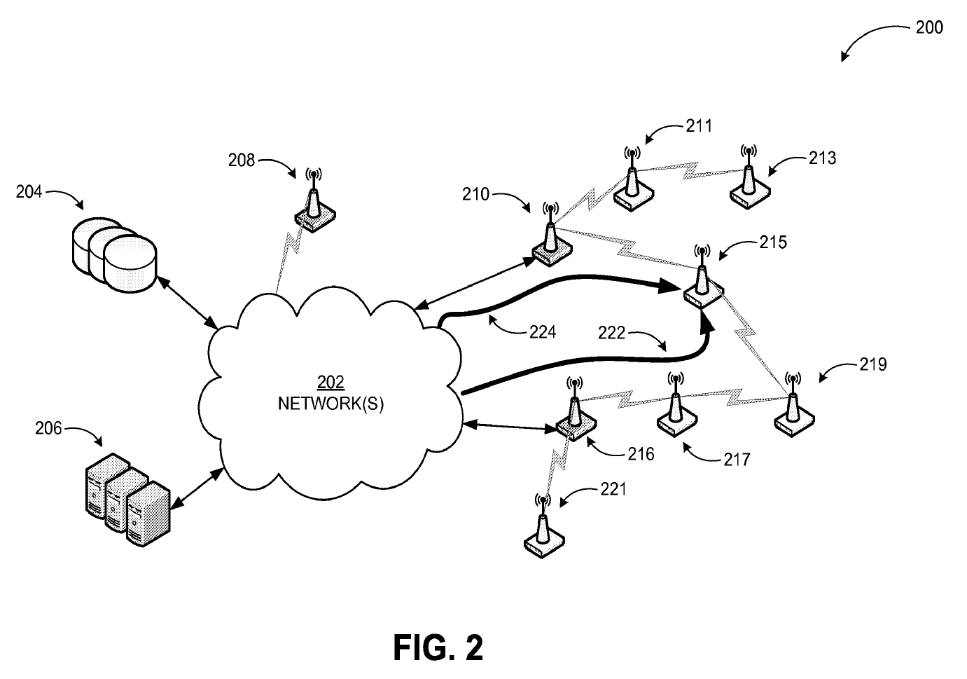

FIG. 2 illustrates another example configuration of the system of FIG. 1, where some scalable networked devices may be defined by more than one route/name, arranged in accordance with at least some embodiments described herein.

Referring to a diagram 200, a simplified version of the system of FIG. 1 may include a network 202 with administration server(s) 206 and data stores 204. NCDs 208, 210, and 216 are directly connected to the network 202 with their respective network identifiers. SADs 211 and 215 are connected to the network 202 through the NCD 210. SADs 217 and 221 are connected to the network 202 through the NCD 216. An SAD 213 is connected to the network 202 through the NCD 210 and the SAD 211.

An SAD 219 can connect to the network 202 through either the SAD 215 and the NCD 210 (a route 224) or the SAD 217 and the NCD 216 (a route 226). Thus, there are two possible routes 224, 226 for the SAD 219. One of the possible routes may be preferable over the other route because of bandwidth, connectivity, and/or traffic issues. Thus, one of the NCDs 210 or 216 may determine the optimal route based on the above listed or other metrics and update a mapping table upon discovering the SAD 219.

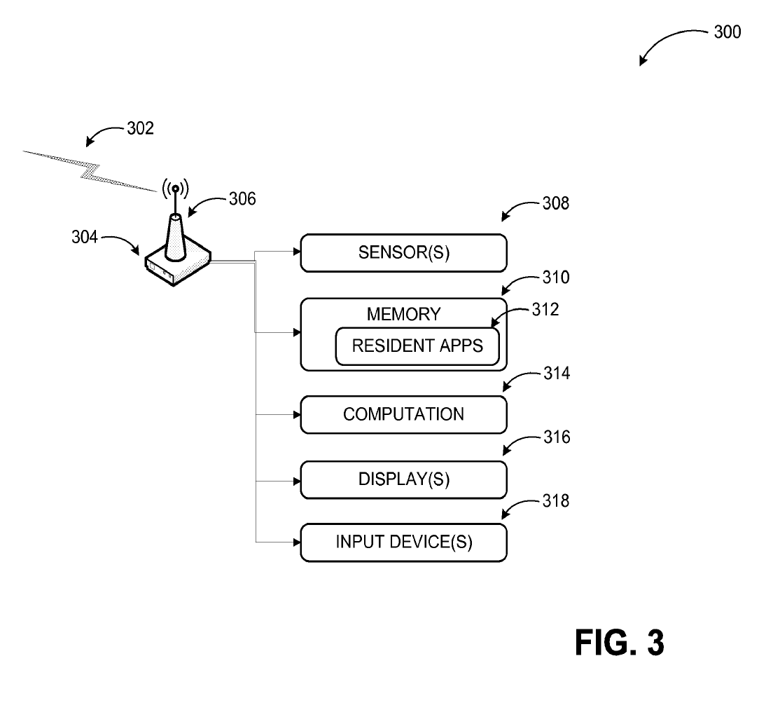

FIG. 3 illustrates example functional modules of a scalable networked device, arranged in accordance with at least some embodiments described herein.

As discussed above, embodiments are directed to methods for naming, routing of information, searching, and updating large scale networks of ubicomp devices (scalable networked devices), of which some may have a direct connection to the network and some may be connected through one or more intermediary devices. An example of such a network may be a street which has energy harvesting sensors spread through it, which can provide information about temperature, pressure, sound, humidity, gases or contaminants, passerby, imagery, or periodically updated low power displays such as public transportation information or other such elements. The network may also have at least one element which has a fixed (wireless or wired) connection to the network. In the above example, the devices at the street may be accessed through these one or more elements. Typically, a broadcast range of the ubicomp devices may be short (e.g., a few meters) to save on broadcast power. So, the typical scenario is that each device receives a broadcast, and then retransmits it on to its destination. One of the challenges in these networks is to create routing algorithms to prevent the entire mesh of devices start broadcasting, and in a worst-case scenario broadcasting in a never ending loop without reaching the target device.

One of the components of a system according to some embodiments is a naming convention, which is a combination of the network identifier of a network connected device (NCD) and standalone devices (SADs) in the route as described previously. A SAD index refers to a table, which may be found in each respective SAD. The table may include an identifier for the connected SADs. The table may be built up when a new SAD checks its surroundings and connects to the network as described herein.

According to other embodiments, a spider like algorithm may traverse the mesh, update and optimize the links, and report on device status. The information the spider gleans may be maintained in servers on the web and may be searchable like a search index table. Hence, if a user wishes to access a temperature at a given location, the user may perform a search for temperature and the desired location, and receive a link which is the network identifier and SAD route to the specific sensor, with a command to feedback the temperature at that time.

While network identifier standards such as IPV6 may enable a very large number of network identifiers for networked devices, a complexity and overhead associated with routing via such conventions is not addressed by the naming standards. The overhead and complexity of standards like IPV6 may cause problems for low power, low computing and memory devices spread in a ubicomp setting. A system according to embodiments may address by employing, in a general sense, a distributed routing table for low power networks and optimizing routing methods by continuously updating the routes to a best available route.

An SAD or an NCD may have certain features and functions related to the ubiquitous computing environment. Such features and functions may include, but are not limited to sensors (e.g., temperature, camera, pressure, vibration, GPS, etc.), location of device, power status of the device, a functionality of the device and/or associated sensors, a computing power of the device, a memory of the device, resident applications on the device, bandwidth and/or connections associated with the device, displays or other input/output components associated with the device.

In a system according to embodiments, users may be enabled to search for SADs and NCDs based on the above-described and other features and functions, and receive an optimized route to the device in response. Then, using the provided route, the users may query the found device(s) for information or instruct it to perform one or more tasks.

Referring to a diagram 300, some of the features of an example scalable networked device are illustrated. The scalable networked device may include a main computing component 304 and a communication module 306. The latter may be a wireless communication module such as a wireless Local Area Network (WLAN) module, a cellular communication module, or similar that enables the scalable networked device to communicate with other devices in its vicinity through wireless means 302. The main computing component 304 may include computational modules 314 such as one or more processors and memory 310, where one or more resident applications 312 may reside. Additional modules such as display(s) 316 and/or input device(s) 318 may be integrated to the main computing component 304 or they may be external components. Similarly, one or more sensors 308 may be integrated to the main computing component 304 or employed as external components.

In an example scenario, a number of scalable networked devices with weather sensors (temperature, humidity, pressure, etc.) may be placed around different cities. Routing and functionality of such devices may be stored as discussed above in distributed location within the system such that a user can perform a search based on a location and functionality of a device. The user may receive route (and/or functionality) information in response to his/her search and then query the found device to obtain weather information for a particular location directly from the scalable networked device.

While embodiments have been discussed above using specific examples, components, and configurations in FIGS. 1 through 3, they are intended to provide a general guideline to be used for enabling dynamic mapping of scalable networked devices such as ubiquitous computing devices. These examples do not constitute a limitation on the embodiments, which may be implemented using other components, modules, and configurations using the principles described herein. For example, any suitable special purpose or general purpose computing device may be used for as a scalable networked device. Furthermore, actions discussed above may be performed in various orders, especially in an interlaced fashion.

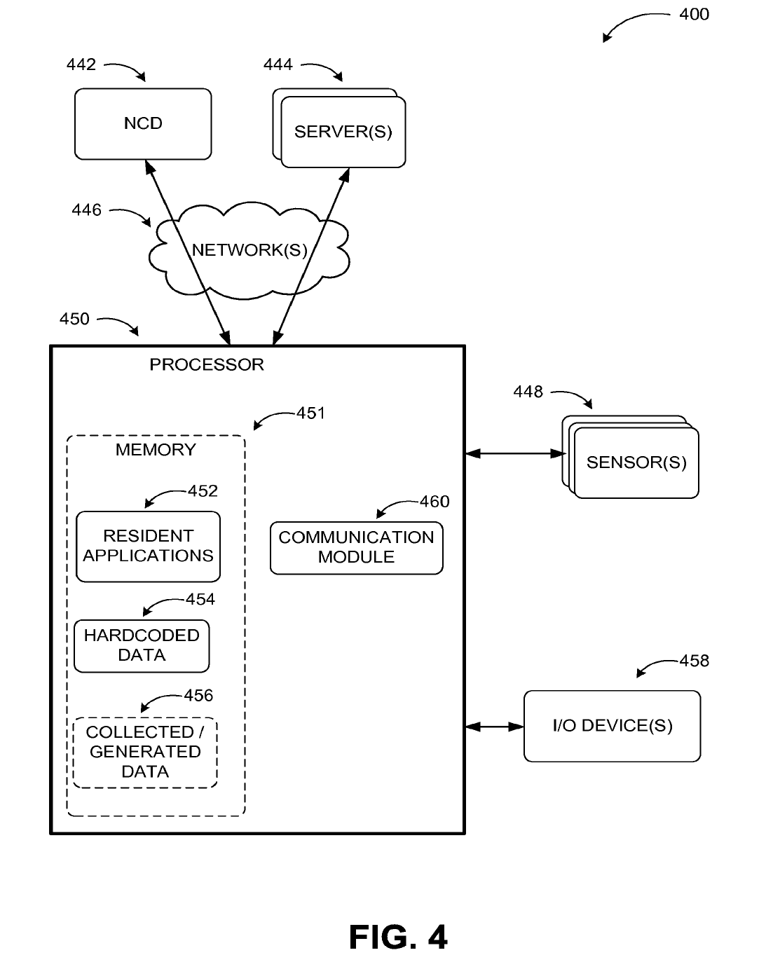

FIG. 4 illustrates a special purpose processor that may be employed in a scalable networked device, arranged in accordance with at least some embodiments described herein.

As discussed previously, a system of scalable networked devices may be mapped employing a naming convention that enables an optimized route to the devices through device search algorithms for network-connected and non-network connected devices. According to some embodiments, a scalable networked device may be implemented as a special purpose device with a processor 450 and one or more components such as sensor(s) 448 and input/output (I/O) device(s) 458 shown in a diagram 400. The processor 450 may be configured to communicate with computing devices such as servers 444 managing various aspects of the networked system (e.g., routing, storing search data, etc.) over one or more networks 446 and an NCD 442. If the scalable networked device of the processor 450 is not directly connected to the networks 446 (i.e., does not have a network identifier), the network identifier of the NCD 442 may be used in the name of the scalable networked device for optimized routing.

The processor 450 may store in its memory 451 resident applications 452, hardcoded data 454, and/or collected/generated data 456. The resident applications 452 may be any applications that may be executed as part of a functionality of the scalable networked device. The hardcoded data 454 may be information stored in a non-volatile memory of the scalable networked device such as definition of the device's functionality, capabilities, identification, etc. In example scenarios, where the scalable networked device may collect data from its environment (e.g., a sensor) or generate data as part of its functionality, such data may be stored in the memory 451 as well. The processor 450 may further include a communication module 460 for communicating with the components of the scalable networked device.

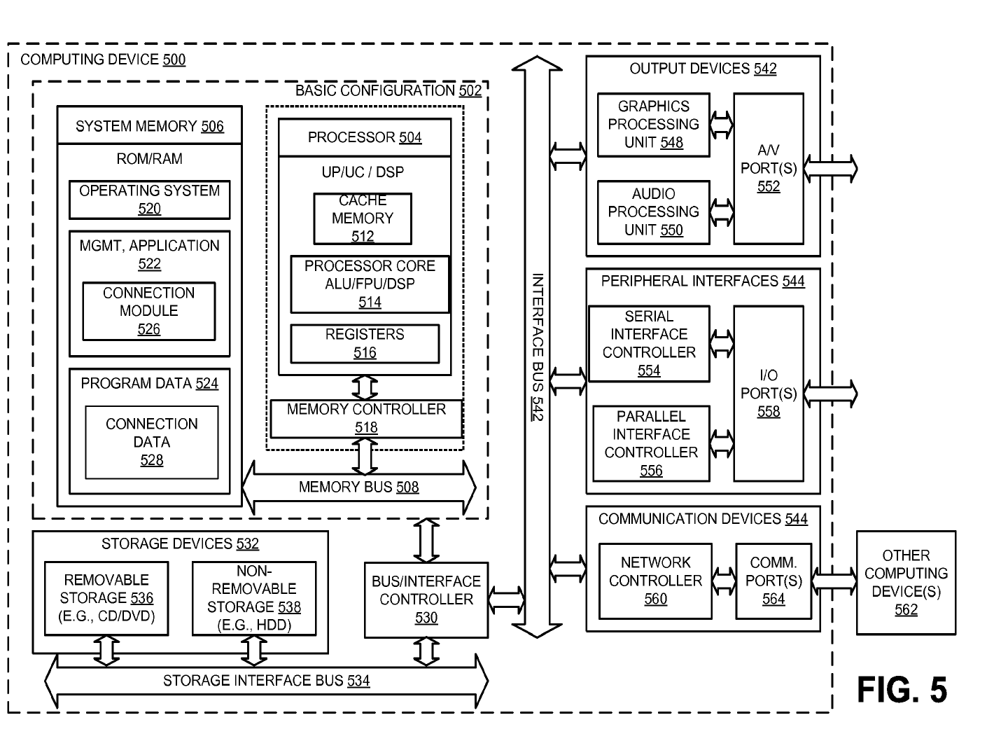

FIG. 5 illustrates a general purpose computing device, which may be used to implement scalable networked device dynamic mapping, arranged in accordance with at least some embodiments described herein. In a very basic configuration 502, a computing device 500 typically includes one or more processors 504 and a system memory 506. A memory bus 508 may be used for communicating between the processor 504 and the system memory 506.

Depending on the desired configuration, the processor 504 may be of any type including but not limited to a microprocessor (μP), a microcontroller (μC), a digital signal processor (DSP), or any combination thereof. The processor 504 may include one more levels of caching, such as a level cache memory 512, a processor core 514, and registers 516. The example processor core 514 may include an arithmetic logic unit (ALU), a floating point unit (FPU), a digital signal processing core (DSP Core), or any combination thereof. An example memory controller 518 may also be used with the processor 504, or in some implementations the memory controller 518 may be an internal part of the processor 504.

Depending on the desired configuration, the system memory 506 may be of any type including but not limited to volatile memory (such as RAM), non-volatile memory (such as ROM, flash memory, etc.) or any combination thereof. The system memory 506 may include an operating system 520, one or more applications such as management application 522, and program data 524. The management application 522 may include connection module 526, which may enable optimized routing to scalable networked devices as described herein. The program data 524 may include, among other data, connection data 528 associated with routing users to scalable networked devices based on the devices' functionality, location, and similar attributes. This described the basic configuration 502 is illustrated in FIG. 5 by those components within the inner dashed line.

The computing device 500 may have additional features or functionality, and additional interfaces to facilitate communications between the basic configuration 502 and any required devices and interfaces. For example, a bus/interface controller 530 may be used to facilitate communications between the basic configuration 502 and one or more data storage devices 532 via a storage interface bus 534. The data storage devices 532 may be removable storage devices 536, non-removable storage devices 538, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

The system memory 506, the removable storage devices 536 and the non-removable storage devices 538 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by the computing device 500. Any such computer storage media may be part of the computing device 500.

The computing device 500 may also include an interface bus 540 for facilitating communication from various interface devices (e.g., output devices 542, peripheral interfaces 544, and communication devices 546) to the basic configuration 502 via bus/interface controller 530. Some example output devices 542 include a graphics processing unit 548 and an audio processing unit 550, which may be configured to communicate to various external devices such as a display or speakers via one or more A/V ports 552. Example peripheral interfaces 544 include a serial interface controller 554 or a parallel interface controller 556, which may be configured to communicate with external devices such as input devices (e.g., keyboard, mouse, pen, voice input device, touch input device, etc.) or other peripheral devices (e.g., printer, scanner, etc.) via one or more I/O ports 558. An example communication device 546 includes a network controller 560, which may be arranged to facilitate communications with one or more other computing devices 562 over a network communication link via one or more communication ports 564.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 500 may be implemented as a part of a general purpose or specialized server, mainframe, or similar computer that includes any of the above functions. The computing device 500 may also be implemented as a personal computer including both laptop computer and non-laptop computer configurations.

Example embodiments may also include methods. These methods can be implemented in any number of ways, including the structures described herein. One such way is by machine operations, of devices of the type described in the present disclosure. Another optional way is for one or more of the individual operations of the methods to be performed in conjunction with one or more human operators performing some of the operations while other operations are performed by machines. These human operators need not be collocated with each other, but each can be only with a machine that performs a portion of the program. In other examples, the human interaction can be automated such as by pre-selected criteria that are machine automated.

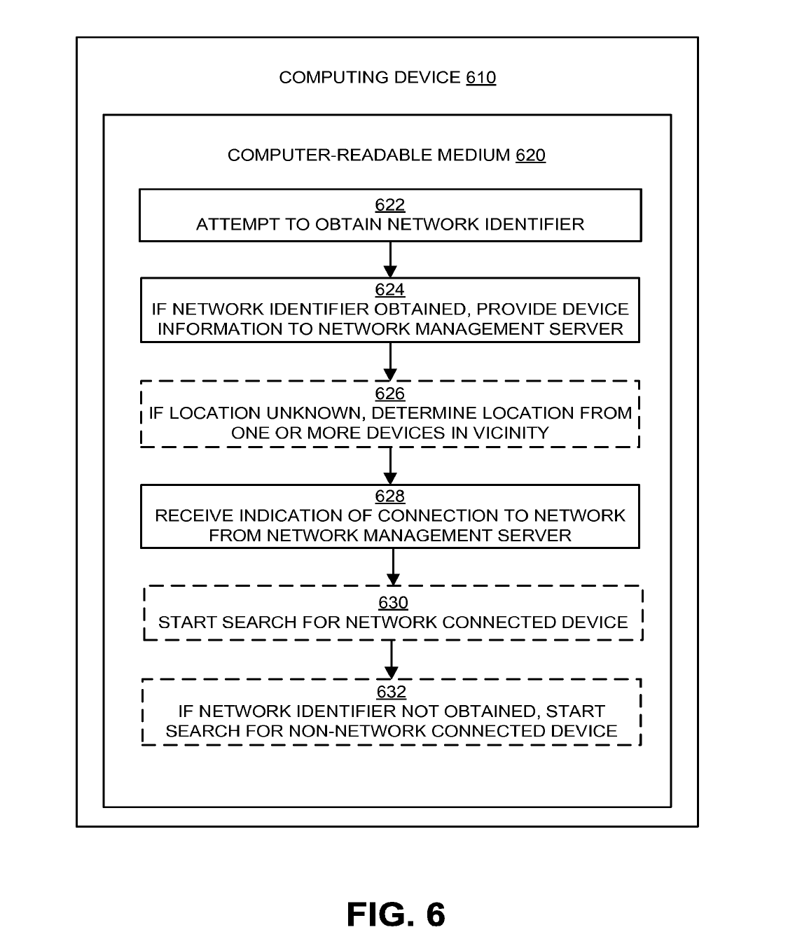

FIG. 6 is a flow diagram illustrating an example method for starting up a scalable networked device such as one of the devices in FIG. 1 or FIG. 2, arranged in accordance with at least some embodiments described herein. Example methods may include one or more operations, functions or actions as illustrated by one or more of blocks 622, 624, 626, 628, 630, and/or 632. The operations described in blocks 622 through 632 may also be stored as computer-executable instructions in a computer-readable medium such as a computer-readable medium 620 of a computing device 610.

A process of starting up a scalable networked device may begin at block 622, “ATTEMPT TO OBTAIN NETWORK IDENTIFIER”. At block 622, a scalable networked device such as the scalable networked devices 110 or 115 of FIG. 1 may attempt to connect to a network server such as a domain name server (DNS) to obtain an identifier as part of its initialization process. If the device is directly connected to the network, it may obtain such as identifier, for example an IP address from a server of the network.

Block 622 may be followed by block 624, “IF NETWORK IDENTIFIER OBTAINED, PROVIDE DEVICE INFORMATION TO NETWORK MANAGEMENT SERVER.” At block 624, the scalable networked device may provide device information such as its network identifier, attributes, capabilities, etc. to a network management server, that is if the device was able to obtain the network identifier at block 622.

Block 624 may be followed by optional block 626, “IF LOCATION UNKNOWN, DETERMINE LOCATION FROM ONE OR MORE DEVICES IN VICINITY.” In some examples, one of the attributes of the scalable networked device may include a location of the device. If the device is not aware of its location, the location information may be obtained from one or more similar devices in the device's vicinity at block 626. The location information may include global positioning service (GPS) data, network data, or similar information.

Optional block 626 may be followed by block 628, “RECEIVE INDICATION OF CONNECTION TO NETWORK FROM NETWORK MANAGEMENT SERVER.” At block 628, the scalable networked device may receive an acknowledgment from the network management server indicating the device is connected to the network.

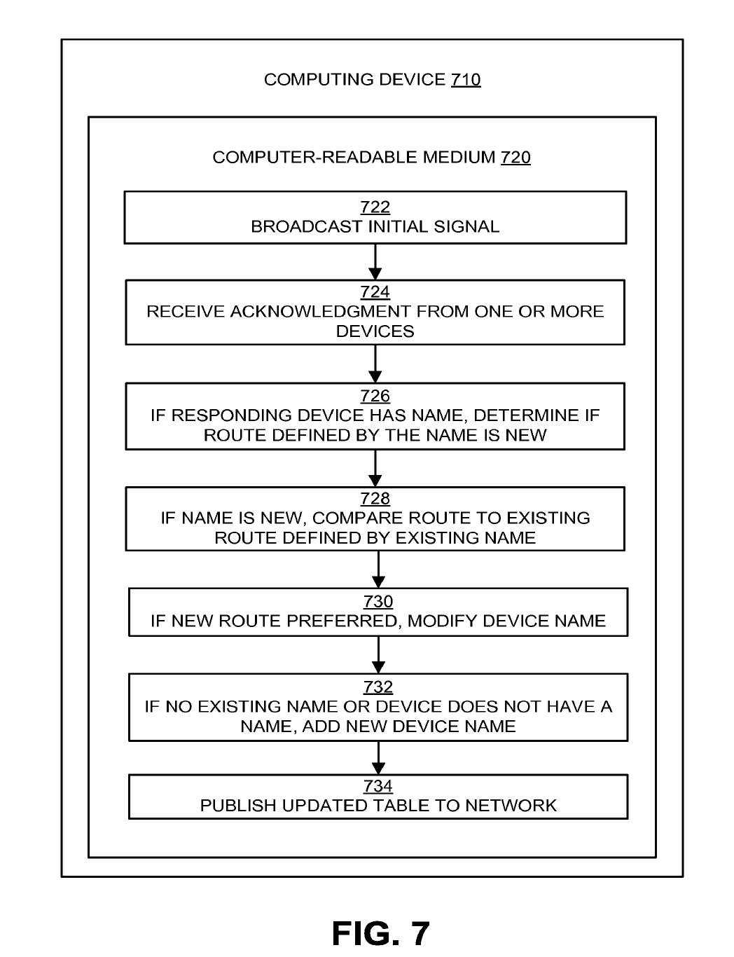

Block 628 may be followed by optional block 630, “START SEARCH FOR NETWORK CONNECTED DEVICE.” Upon receiving acknowledgment of network connection at block 628, the scalable networked device may initiate a search algorithm as described in FIG. 7 for other network connected scalable devices at optional block 630.

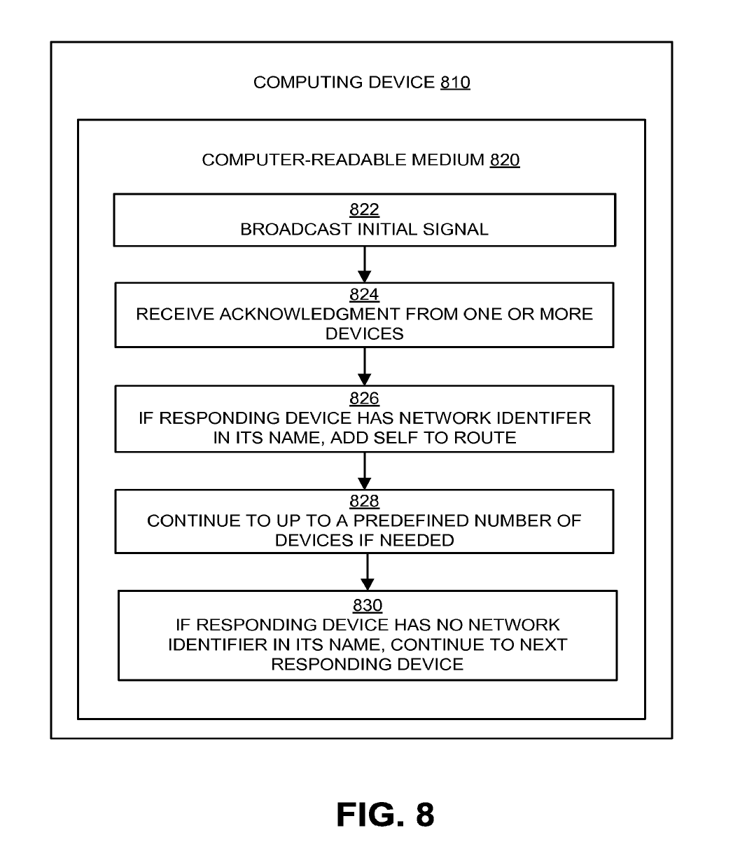

Optional block 630 may be followed by optional block 632, “IF NETWORK IDENTIFIER NOT OBTAINED, START SEARCH FOR NON-NETWORK CONNECTED DEVICE.” If the scalable networked device is unable to obtain a network identifier, the scalable networked device may initiate a search algorithm as described in FIG. 8 for other non-network connected scalable devices at optional block 632.

FIG. 7 is a flow diagram illustrating an example method of searching for other devices by a network-connected scalable networked device such as device 110 in FIG. 1, arranged in accordance with at least some embodiments described herein. Example methods may include one or more operations, functions or actions as illustrated by one or more of blocks 722, 724, 726, 728, 730, 732, and/or 734. The operations described in blocks 722 through 734 may also be stored as computer-executable instructions in a computer-readable medium such as a computer-readable medium 720 of a computing device 710.

A process of searching for other devices may begin at block 722, “BROADCAST INITIAL SIGNAL”. At block 722, a scalable networked device such as the scalable networked device 110 of FIG. 1 may broadcast an initial “hello” or similar signal to any listening devices in the network.

Block 722 may be followed by block 724, “RECEIVE ACKNOWLEDGMENT FROM ONE OR MORE DEVICES.” At block 724, responses may be received from more than one scalable networked device at the scalable networked device that was able to obtain a network identifier as described in FIG. 6.

Block 724 may be followed by block 726, “IF RESPONDING DEVICE HAS NAME, DETERMINE IF ROUTE DEFINED BY THE NAME IS NEW.” At block 726, the scalable networked device performing the search algorithm may determine whether a responding scalable networked device has a name. According to the naming convention described above, a name indicates a route for the discovered device. The name of the discovered device may exist in a table stored by the scalable networked device performing the search or it may be a new name. Thus, the name of the discovered device may indicate a new route that may be different from an existing route to the discovered scalable networked device.

Block 726 may be followed by block 728, “IF NAME IS NEW, COMPARE ROUTE TO EXISTING ROUTE DEFINED BY EXISTING NAME.” At block 728, the scalable networked device performing the search algorithm may compare the route defined by the newly discovered name to an existing route for the same device defined by an existing name according to the previously described naming convention.

Block 728 may be followed by block 730, “IF NEW ROUTE PREFERRED, MODIFY DEVICE NAME.” At block 730, the scalable networked device performing the search algorithm may determine if the new route defined by the newly discovered name is preferred over one or more existing routes for the same scalable networked device. The preference may be due to distance (geographic or network topology based), network traffic, or comparable reasons. If the new route is preferred, the scalable networked device performing the search algorithm may modify the stored name for the discovered scalable networked device to the new name defining the preferred route.

Block 730 may be followed by block 732, “IF NO EXISTING NAME OR DEVICE DOES NOT HAVE A NAME, ADD NEW DEVICE NAME.” If the newly discovered device has no existing name (i.e., no route is defined for the device at the scalable networked device performing the search algorithm), the new name (and the defined route) may be stored by the scalable networked device performing the search algorithm at block 732.

Block 732 may be followed by block 734, “PUBLISH UPDATED TABLE TO NETWORK.” At block 734, the scalable networked device performing the search algorithm may publish its updated connection table to the network such that the information including newly discovered scalable networked devices may be stored by one or more servers and can be searchable by users based on attributes of the newly discovered devices.

FIG. 8 is a flow diagram illustrating an example method of searching for other devices by a non-network-connected scalable networked device such as device 115 in FIG. 1, arranged in accordance with at least some embodiments described herein. Example methods may include one or more operations, functions or actions as illustrated by one or more of blocks 822, 824, 826, 828, and/or 830. The operations described in blocks 822 through 830 may also be stored as computer-executable instructions in a computer-readable medium such as a computer-readable medium 820 of a computing device 810.

A process of searching for other devices by a non-networked device may begin at block 822, “BROADCAST INITIAL SIGNAL”. At block 822, a scalable networked device that is not connected directly to a network (i.e., does not have a network identifier) such as the scalable networked device 115 of FIG. 1 may broadcast an initial “hello” or similar signal to any listening devices.

Block 822 may be followed by block 824, “RECEIVE ACKNOWLEDGMENT FROM ONE OR MORE DEVICES.” At block 824, responses may be received from more than one other device at the scalable networked device that lacks a network identifier as described in FIG. 6.

Block 824 may be followed by block 826, “IF RESPONDING DEVICE HAS NETWORK IDENTIFIER IN ITS NAME, ADD SELF TO ROUTE.” At block 826, the scalable networked device without the network identifier that is performing the search may add itself to the route defined by the name of a responding device if the responding device has a name (that defines the route).

Block 826 may be followed by block 828, “CONTINUE TO UP TO A PREDEFINED NUMBER OF DEVICES IF NEEDED.” At block 828, the scalable networked device without the network identifier that is performing the search may continue the search adding itself to the routes defined by the names of discovered devices up to a predefined number. Multiple routes may be defined for a single scalable networked device in a system according to embodiments. Thus, if one of the routes becomes unavailable or undesirable due to bandwidth, traffic, etc. issues, the device may still be reachable through another route.

Block 828 may be followed by block 830, “IF RESPONDING DEVICE HAS NO NETWORK IDENTIFIER IN ITS NAME, CONTINUE TO NEXT RESPONDING DEVICE.” During the search if one of the responding devices has no name indicating the device has no direct connection to the network, the scalable networked device without the network identifier that is performing the search may continue the search skipping to a next responding device at block 830.

The functions performed at the blocks in the above described processes are for illustration purposes. Dynamic mapping of scalable networked devices may be implemented by similar processes with fewer or additional functions. In some examples, the functions may be performed in a different order. In some other examples, various functions may be eliminated. In still other examples, various functions may be divided into additional functions, or combined together into fewer functions.

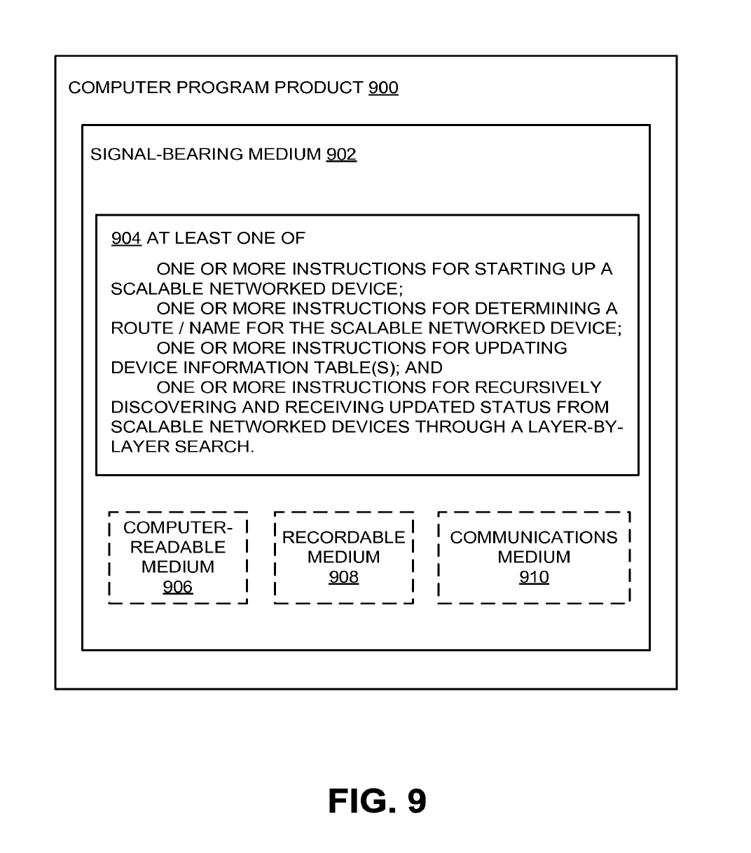

FIG. 9 illustrates a block diagram of an example computer program product, arranged in accordance with at least some embodiments described herein. In some examples, as shown in FIG. 9, the computer program product 900 may include a signal bearing medium 902 that may also include machine readable instructions 904 that, when executed by, for example, a processor, may provide the functionality described above with respect to FIG. 4 and FIG. 5. Thus, for example, referring to the processor 504, the connection module 526 may undertake one or more of the tasks shown in FIG. 9 in response to the instructions 904 conveyed to the processor 504 by the medium 902 to perform actions associated with starting up a scalable networked device, determining a route/name for the scalable networked device, updating device information table(s), and/or recursively discovering and receiving updated status from scalable networked devices through a layer-by-layer search.

In some implementations, the signal bearing medium 902 depicted in FIG. 9 may encompass a computer-readable medium 906, such as, but not limited to, a hard disk drive, a Compact Disc (CD), a Digital Versatile Disk (DVD), a digital tape, memory, etc. In some implementations, the signal bearing medium 902 may encompass a recordable medium 908, such as, but not limited to, memory, read/write (R/W) CDs, R/W DVDs, etc. In some implementations, the signal bearing medium 902 may encompass a communications medium 910, such as, but not limited to, a digital and/or an analog communication medium (e.g., a fiber optic cable, a waveguide, a wired communications link, a wireless communication link, etc.). Thus, for example, the program product 900 may be conveyed to one or more modules of the processor 904 by an RF signal bearing medium, where the signal bearing medium 902 is conveyed by the wireless communications medium 910 (e.g., a wireless communications medium conforming with the IEEE 802.11 standard).

According to some examples, a method for a scalable networked device to join a network may include attempting to obtain a network identifier at a first scalable networked device and providing first scalable networked device information to a network management server such that the first scalable networked device becomes discoverable within the network based on at least one of a name, a functionality, and/or a status of the first scalable networked device if the network identifier is obtained. The method may also include performing a search at the first scalable networked device for at least a second scalable networked device that is communicatively coupled to the first scalable networked device upon acknowledgment by the network management server.

The first scalable networked device information provided to the network management server may include a name, a functionality, and/or a status of the first scalable networked device. The name may include the network identifier of the first scalable networked device. The first scalable networked device information provided to the network management server may further include a location of the first scalable networked device.

According to some examples, the method may also include if an actual location of the first scalable networked device is unknown, determining the location of the first scalable networked device from locations of one or more other scalable networked devices within a vicinity of the first scalable networked device. Performing the search for at least a second scalable networked device may include broadcasting an initial signal, acknowledging received responses to the initial signal, and if a scalable networked device name is received from the second scalable networked device, comparing the second scalable networked device's existing route defined by the received name to a new route through the first scalable networked device and one of adding the new route or changing the existing route at a scalable networked device table associated with the first scalable networked device. If a scalable networked device name is not received from the second scalable networked device, the performing the search may further include updating the scalable networked device table with a name, a location, a functionality, and a status of the second scalable networked device, wherein the name of the second scalable networked device is the network identifier of the first scalable networked device.

According to other examples, the method may further include recursively continuing to perform the search for other scalable networked devices communicatively coupled to the first scalable networked device directly or indirectly through at least one other scalable networked device. If the network identifier is not obtained, the method may include broadcasting an initial signal, receiving a response from another scalable networked device. If the response includes a network identifier in a name of the other scalable networked device, the method may include enabling the other scalable networked device to add the first scalable networked device to a list of connected scalable networked devices at the other scalable networked device, else processing another response from a further scalable networked device.

The name of the first scalable networked device may include the network identifier in the other scalable networked device's name and a name of at least one scalable networked device between the other scalable networked device and the first scalable networked device defining a route for the first scalable networked device. The method may also include enabling the first scalable networked device information to be stored in a plurality of devices within the network such that at least one of a name, a location, a functionality, and a status of the first scalable networked device is searchable. The functionality of the first scalable networked device may include at least from a set of: temperature sensing, humidity sensing, pressure sensing, vibration sensing, location determination, still image capture, video capture, audio capture, and/or motion detection. Moreover, at least a portion of the functionality of the first scalable networked device may be performed by an external module coupled to the first scalable networked device.

According to some examples, a scalable networked device may include a memory adapted to store instructions, a wireless communication module, and a processing unit configured to communicate with a network in conjunction with the stored instructions. The processor may attempt to obtain a network identifier, provide information to a network management server such that the scalable networked device becomes discoverable within the network based on at least one of a name, a functionality, and/or a status of the scalable networked device if the network identifier is obtained, and perform a search for at least one other scalable networked device that is communicatively coupled to the scalable networked device upon acknowledgment by the network management server.

The information provided to the network management server may include a name, a functionality, and/or a status of the scalable networked device. The name may include the network identifier of the scalable networked device. The information provided to the network management server may further include a location of the scalable networked device. The processor may also determine the location of the scalable networked device from locations of one or more other scalable networked devices within a vicinity of the scalable networked device if an actual location of the scalable networked device is unknown. The report may include one or more of a summary of the performed analysis tasks, a summary of the analyzed data, or the analyzed data.

According to other examples, the processor may perform the search for the at least one other scalable networked device by broadcasting an initial signal, acknowledging received responses to the initial signal, and comparing the other scalable networked device's existing route defined by the received name to a new route through the scalable networked device and one of adding the new route or changing the existing route at a scalable networked device table associated with the scalable networked device if a scalable networked device name is received from the other scalable networked device. If a scalable networked device name is not received from the other scalable networked device, the processor may perform the search by updating the scalable networked device table with a name, a location, a functionality, and a status of the other scalable networked device, where the name of the other scalable networked device is the network identifier of the scalable networked device.

The processor may recursively continue to perform the search for other scalable networked devices communicatively coupled to the scalable networked device directly or indirectly through at least one further scalable networked device. If the network identifier is not obtained, the processor may broadcast an initial signal, receive a response from another scalable networked device, and enable the other scalable networked device to add the scalable networked device to a list of connected scalable networked devices at the other scalable networked device if the response includes a network identifier in a name of the other scalable networked device. Otherwise, the processor may process another response from a further scalable networked device.

The name of the scalable networked device may include the network identifier in the other scalable networked device's name and an a name of at least one scalable networked device between the other scalable networked device and the scalable networked device defining a route for the scalable networked device. The functionality of the scalable networked device may include at least from a set of: temperature sensing, humidity sensing, pressure sensing, vibration sensing, location determination, still image capture, video capture, audio capture, and/or motion detection. At least a portion of the functionality of the scalable networked device may be performed by one of an external module coupled to the scalable networked device and an integrated sensor module.

According to further examples, a system of discoverable scalable networked devices may include a first server, a second server, and a plurality of scalable networked devices. The first server may provide a network identifier to each scalable networked device directly coupled to a network. The second server may receive device information tables from each scalable networked device directly coupled to the network and render the scalable networked devices discoverable by publishing the device information tables, where the device information tables include a name, a functionality, a location, and/or a status of each scalable networked device directly or indirectly coupled to the network. A name of each scalable networked device may identify a route of the device.

The name of a scalable networked device may include the network identifier of the scalable networked device if the scalable networked device is directly coupled to the network, or the network identifier of a first scalable networked device directly coupled to the network and in a route of the scalable networked device, and names of any other intervening scalable networked devices if the scalable networked device is coupled to the network through one or more scalable networked devices. The system may also include a third server. the third server may receive a search request from a user defining a functionality and a location of a desired scalable networked device, determine the desired scalable networked device by performing the search on the device information tables, and return a route of the desired scalable networked device to the user as defined by the name of the desired scalable networked device. The user may be enabled to query the desired scalable networked device for data associated with the defined functionality employing the returned route.

According to yet other examples, a method for updating a scalable networked device network status may include broadcasting an initial signal to the scalable networked devices that include a network identifier of a first scalable networked device in their routes, upon receiving an acknowledgment, requesting device information from responding scalable networked devices, and for each responding scalable networked device, recursively requesting device information from other scalable networked devices coupled to the responding devices until layers of scalable networked devices associated with the first scalable networked device are exhausted. The method may also include associating the scalable networked device with the network identifier of the first scalable networked device if a scalable networked device without a network identifier in its name is discovered.

The device information may include a name, a functionality, a location and/or a status of the each scalable networked device. The method may further include broadcasting the initial signal to and requesting device information from one or more scalable networked devices associated with a second scalable networked device that has a network identifier upon exhausting of the layers of scalable networked devices associated with the first scalable networked device.

There is little distinction left between hardware and software implementations of aspects of systems; the use of hardware or software is generally (but not always, in that in certain contexts the choice between hardware and software may become significant) a design choice representing cost vs. efficiency tradeoffs. There are various vehicles by which processes and/or systems and/or other technologies described herein may be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples may be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g. as one or more programs running on one or more microprocessors), as firmware, or as virtually any combination thereof, and that designing the circuitry and/or writing the code for the software and or firmware would be well within the skill of one of skill in the art in light of this disclosure.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Versatile Disk (DVD), a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity of gantry systems; control motors for moving and/or adjusting components and/or quantities).

A typical data processing system may be implemented utilizing any suitable commercially available components, such as those typically found in data computing/communication and/or network computing/communication systems. The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couplable”, to each other to achieve the desired functionality. Specific examples of operably couplable include but are not limited to physically connectable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method for a scalable networked device to join a network, the method comprising:
attempting to obtain a network identifier at a first scalable networked device;
if the network identifier is obtained, providing first scalable networked device information including a name, a functionality, and/or a status of the first scalable networked device to a network management server such that the first scalable networked device becomes discoverable within the network based on at least one of the name, the functionality, and/or the status of the first scalable networked device; and
if the network identifier is not obtained, performing a search for connected device by:
broadcasting an initial signal;
receiving a response from another scalable networked device;
if the response includes a network identifier in a name of the other scalable networked device, enabling the other scalable networked device to add the first scalable networked device to a list of connected scalable networked devices at the other scalable networked device; else
processing another response from a further scalable networked device.

2. (canceled)

3. The method according to claim 1, wherein the name includes the network identifier of the first scalable networked device.

4. The method according to claim 1, wherein the first scalable networked device information provided to the network management server further includes a location of the first scalable networked device.

5. The method according to claim 4, further comprising
if an actual location of the first scalable networked device is unknown, determining the location of the first scalable networked device from locations of one or more other scalable networked devices within a vicinity of the first scalable networked device.

6. The method according to claim 1, wherein performing the search for at least a second scalable networked device comprises:
broadcasting an initial signal;
acknowledging received responses to the initial signal;
if a scalable networked device name is received from the second scalable networked device, comparing the second scalable networked device's existing route defined by the received name to a new route through the first scalable networked device and one of adding the new route or changing the existing route at a scalable networked device table associated with the first scalable networked device; else
updating the scalable networked device table with a name, a location, a functionality, and a status of the second scalable networked device, wherein the name of the second scalable networked device is the network identifier of the first scalable networked device.

7. The method according to claim 6, further comprising
recursively continuing to perform the search for other scalable networked devices communicatively coupled to the first scalable networked device directly or indirectly through at least one other scalable networked device.

8. The method according to claim 1, wherein the name of the first scalable networked device includes the network identifier in the other scalable networked device's name and a name of at least one scalable networked device between the other scalable networked device and the first scalable networked device defining a route for the first scalable networked device.

9. The method according to claim 1, further comprising
enabling the first scalable networked device information to be stored in a plurality of devices within the network such that at least one of a name, a location, a functionality, and a status of the first scalable networked device is searchable, wherein the functionality of the first scalable networked device includes at least from a set of: temperature sensing, humidity sensing, pressure sensing, vibration sensing, location determination, still image capture, video capture, audio capture, and/or motion detection.

10. (canceled)

11. (canceled)

12. A scalable networked device comprising:
a memory configured to store instructions;
a wireless communication module; and
a processing unit configured to communicate with a network in conjunction with the stored instructions, wherein the processor is configured to:
attempt to obtain a network identifier;
if the network identifier is obtained, provide information to a network management server including a name, a functionality, a location, and/or a status of the scalable networked device such that the scalable networked device becomes discoverable within the network based on at least one of the name, the functionality, a location, and/or the status of the scalable networked device; and
if the network identifier is not obtained, perform a search by:
broadcast an initial signal;
receive a response from another scalable networked device;
if the response includes a network identifier in a name of the other scalable networked device, enable the other scalable networked device to add the scalable networked device to a list of connected scalable networked devices at the other scalable networked device; else
process another response from a further scalable networked device.

13. (canceled)

14. The scalable networked device according to claim 12, wherein the name includes the network identifier of the scalable networked device.

15. (canceled)

16. The scalable networked device according to claim 12, wherein the processor is further configured to determine the location of the scalable networked device from locations of one or more other scalable networked devices within a vicinity of the scalable networked device if an actual location of the scalable networked device is unknown.

17. The scalable networked device according to claim 16, wherein the report includes one or more of a summary of the performed analysis tasks, a summary of the analyzed data, or the analyzed data.

18. The scalable networked device according to claim 12, wherein the processor is further configured to perform the search for the at least one other scalable networked device by:
broadcasting an initial signal;
acknowledging received responses to the initial signal;
if a scalable networked device name is received from the other scalable networked device, comparing the other scalable networked device's existing route defined by the received name to a new route through the scalable networked device and one of adding the new route or changing the existing route at a scalable networked device table associated with the scalable networked device; else
updating the scalable networked device table with a name, a location, a functionality, and a status of the other scalable networked device, wherein the name of the other scalable networked device is the network identifier of the scalable networked device.

19. The scalable networked device according to claim 18, wherein the processor is further configured to recursively continue to perform the search for other scalable networked devices communicatively coupled to the scalable networked device directly or indirectly through at least one further scalable networked device.

20. The scalable networked device according to claim 12, wherein the name of the scalable networked device includes the network identifier in the other scalable networked device's name and a name of at least one scalable networked device between the other scalable networked device and the scalable networked device defining a route for the scalable networked device.

21. The scalable networked device according to claim 12, wherein the functionality of the scalable networked device includes at least from a set of: temperature sensing, humidity sensing, pressure sensing, vibration sensing, location determination, still image capture, video capture, audio capture, and/or motion detection, and wherein at least a portion of the functionality of the scalable networked device is performed by one of an external module coupled to the scalable networked device and an integrated sensor module.

22. (canceled)

23. A system of discoverable scalable networked devices, the system comprising:
a first server configured to provide a network identifier to each scalable networked device directly coupled to a network;
a second server configured to:
receive device information tables from each scalable networked device directly coupled to the network; and
render the scalable networked devices discoverable by publishing the device information tables, wherein the device information tables include a name,
a functionality, a location, and/or a status of each scalable networked device directly or indirectly coupled to the network; and
a plurality of scalable networked devices, wherein a name of each scalable networked device identifies a route of the device and includes:
if the scalable networked device is directly coupled to the network, the network identifier of the scalable networked device; and
if the scalable networked device is coupled to the network through one or more scalable networked devices, the network identifier of a first scalable networked device directly coupled to the network and in a route of the scalable networked device, and names of any other intervening scalable networked devices.

24. (canceled)

25. The system of claim 23, further comprising:
a third server configured to:
receive a search request from a user defining a functionality and a location of a desired scalable networked device;
determine the desired scalable networked device by performing the search on the device information tables; and
return a route of the desired scalable networked device to the user as defined by the name of the desired scalable networked device.

26. The system of claim 25, wherein the user is enabled to query the desired scalable networked device for data associated with the defined functionality employing the returned route.

27. A method for updating a scalable networked device network status, the method comprising:
broadcasting an initial signal to the scalable networked devices that include a network identifier of a first scalable networked device in their routes;
upon receiving an acknowledgment, requesting device information from responding scalable networked devices, wherein the device information includes a name, a functionality, a location and/or a status of the each scalable networked device;
for each responding scalable networked device, recursively requesting device information from other scalable networked devices coupled to the responding devices until layers of scalable networked devices associated with the first scalable networked device are exhausted; and
if a scalable networked device without a network identifier in its name is discovered, associating the scalable networked device with the network identifier of the first scalable networked device.

28. (canceled)

29. The method according to claim 27, further comprising
upon exhausting of the layers of scalable networked devices associated with the first scalable networked device, broadcasting the initial signal to and requesting device information from one or more scalable networked devices associated with a second scalable networked device that has a network identifier.
